(19) United States
(12) Patent Application Publication
(10) Pub. No.: US 2002/0035523 A1
(43) Pub. Date: Mar. 21, 2002

(54) Parts acquisition system and parts acquisition method

(75) Inventor: Tomoyuki Yui, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 09/948,223

(22) Filed: Sep. 7, 2001

(30) Foreign Application Priority Data
Sep. 20, 2000 (JP) 2000-286100

(51) Int. Cl. G06F 17/60

(52) U.S. Cl. 705/28

(57) ABSTRACT

The invention includes: a stock control server 13 and a Web server 13 at a first parts maker and a stock control server 23 and a Web server 22 at an X'th parts maker for providing information about a stock status of parts through a network 100: and a server 52 at a market place 50 for receiving information specifying search-subject parts from a terminal of a first producing maker to thereby search for information of the specified parts based on the information about the stock statuses of the parts provided by the Web servers 12 and 22 and then return a search result.

### BACKGROUND OF THE INVENTION

1. Field of the Invention

The invention relates to a system and method for acquiring component-parts which is suitable for obtaining information about parts acquisition using a network.

2. Description of the Related Art

With the prevalence of the internet in use, an environment for easy electronic commerce between corporations has been made available. In particular, a market place for electronic commerce has been critical in order to effectively perform supply chaining over a parts maker and a producing maker (assembly maker). With an increase in the number of the parts makers or producing makers participating in the market place, however, the amount of the parts registered in the market place and the information of those makers has become enormous to impose an excessive demand on the performance, capacity, and operability of the server machine and the database used at the market place, thus resulting in a high operation cost. Besides, expectation for electronic commerce has been more and more expanded, so that more and more corporations would participate in it for sure.

### SUMMARY OF THE INVENTION

In view of the above, it is an object of the invention to provide a parts acquisition system and method for distributing parts information over servers of producing makers who hold the information, to permit a market place to only mediate the information, thus reducing the load on the market place servers and the operator and also the cost of operation. It is another object of the invention to provide a market-place parts acquisition system business method and a parts acquisition method for enabling necessary parts in a short delivery time limit when a producing maker wishes to acquire these parts using electronic commerce.

In order to achieve the object, parts acquisition system of present invention comprising: a first server for providing information about a stock status of parts through said network; and a second server for receiving information specifying search-subject parts and, based on said information about a stock status of parts provided from said first server, searching for information about said specified parts to then return a search result.

In addition, a parts acquisition method of present invention which carried out using a plurality of servers connected to a network, comprising the steps of: providing, at a first server, information about a stock status of parts through said network; receiving, at a second server, information specifying search-subject parts to thereby search for information about said specified parts based on said information about a stock status of parts provided by said first server; and returning a search result.

### BRIEF DESCRIPTION OF THE DRAWINGS

FIG. 1 is a block diagram for showing a configuration of one embodiment of a parts acquisition system according to the invention;

FIG. 2 is a flowchart for showing a procedure of a first parts maker 10 preparing for participating at a market place 50 in the configuration of FIG. 1,

FIG. 3 is a flowchart for showing a procedure for always most recently updating information of parts maker home page 11 in the configuration of FIG. 1;

FIG. 4 is a flowchart for showing a procedure from a step of a producing maker 30 making an inquiry to the market place 50 about his necessary parts up to a step of obtaining the inquiry result;

FIG. 5 is an illustration for showing an example of the parts maker home page 11 of FIG. 1; and

FIG. 6 is an illustration for showing one example of a screen whose contents are to be transmitted from a server 52 of FIG. 1 to a terminal 31 of the first producing maker 30.

### DESCRIPTION OF THE PREFERRED EMBODIMENTS

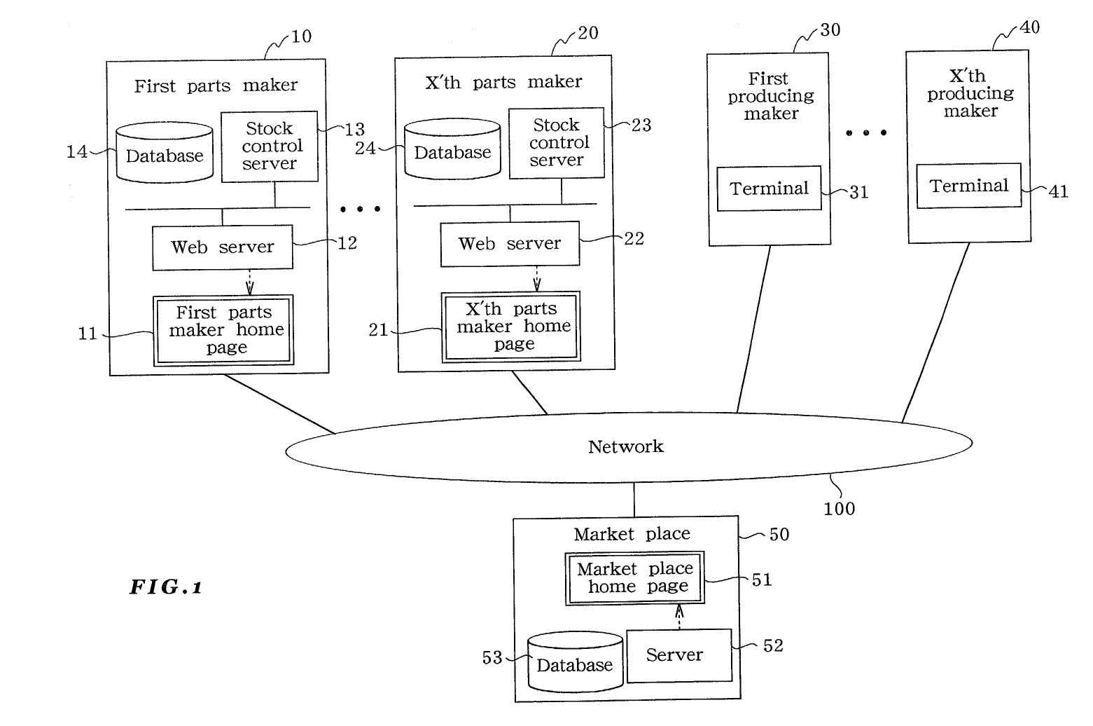

The following will describe one embodiments of a parts acquisition system according to the invention with reference to the drawings. As shown in FIG. 1, a parts acquisition system according to one embodiment of the invention includes a first parts maker 10, an X'th parts maker 20, a first producing maker 30, an X'th producing maker 40, a market place 50, and a communication network 100 such as the internet for connecting these. The first parts maker 10 has a first parts maker home page 11, a Web server 12, a stock control server 13, and a database 14. Likewise, the X'th parts maker 20 has an X'th parts maker home page 21, a Web server 22, a stock control server 23, and a database 24. The first producing maker 30 has a terminal 31. Likewise, the X'th producing maker 40 has a terminal 41. Also, the market place 50 has a market place home page 51, a server 52, and a database 53. Although the parts maker and the producing maker are shown two each in FIG. 1, the number of them is arbitrary, one or larger.

The stock control servers 13 and 23 are used by the parts makers 10 and 20 respectively and each consist of an information processing machine such as a workstation server or a mainframe. The stock control servers 13 and 23 control a stock status of parts, information of which is stored in the databases 14 and 24 respectively. The stock servers 13 and 23 have resident (always operating) therein such a program that monitors the own stock statuses, thus being able to notify the Web servers 12 and 22 of an information change, if any, in the stock quantity stored in the database 14 or 24.

The Web servers 12 and 22 are used by the parts makers 10 and 20 respectively and each consist of an information processing machine such as a workstation. The Web servers 12 and 22 store, respectively, the first parts maker home page 11 and the X'th parts maker home page 21 of the parts makers 10 and 20, thus being able to publicize their homepages to the outside through the network 100. Also, the Web servers 12 and 22 each have a function of receiving information of parts posted from the stock control servers 13 and 23 to update the relevant parts information in their home pages.

The parts maker home page 11 and the X'th parts maker home page 21, which are the parts makers' home pages, each give the parts No. and the shippable stock quantity which they deal with.

The terminals 31 and 41 each consist of an information processing machine such as a personal computer and has a function of transmitting via the network 100 to the market place home page 51 of the market place 50 such parts Nos. and quantities of parts that the producing makers 30 and 40 wish to acquire.

The server 52 is used at the market place 50 and consists of an information processing machine such as a workstation server. The server 52 has a function of storing the market place home page 51 to thereby publicize it to the outside through the network 100. The database 53 is connected to the server 52 to thereby store the network addresses of all parts makers participating at the market place 50. The server 52 has such a function that in response to an inquiry about parts from a production maker it can use the address of a proper parts maker registered in the database 53 to access his home page so as to obtain the information of the parts

Next, the operations of this embodiment are described in detail with reference to FIGS. 1, 2, 3, 4, 5, and 6. Hereinafter, the network 100 refers to the internet.

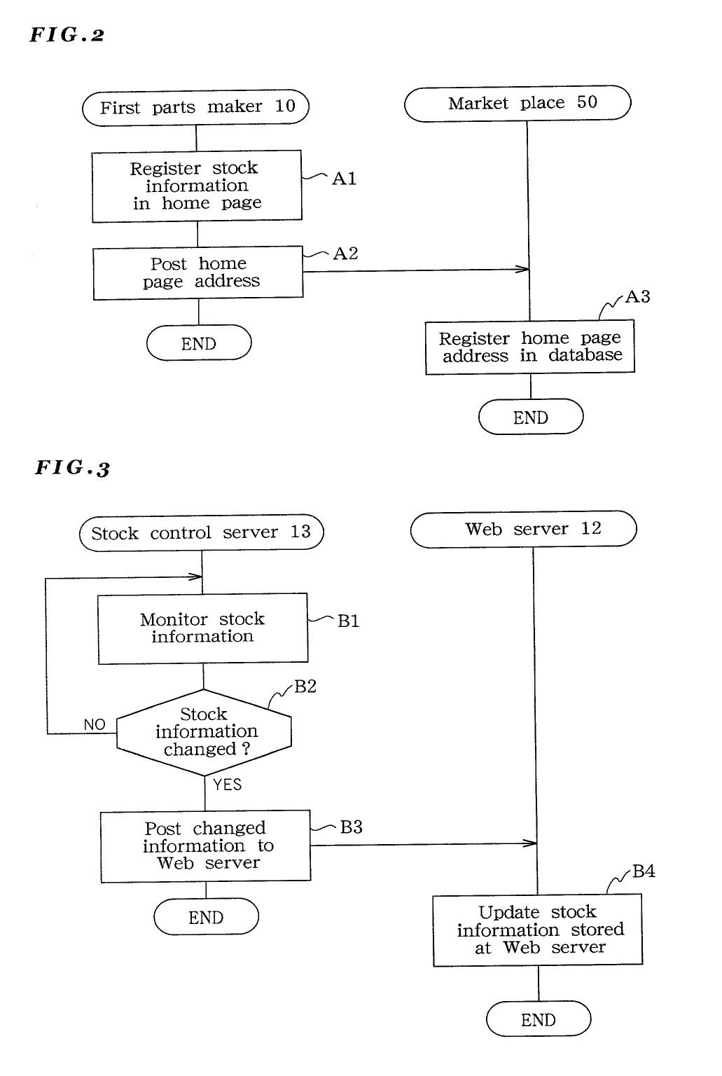

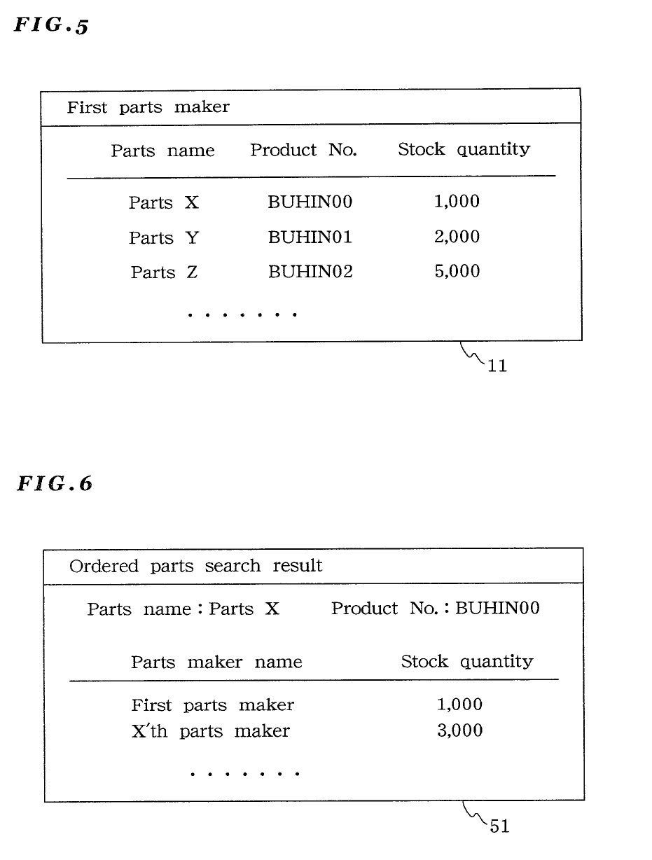

FIG. 2 shows a flowchart of the first parts maker 10 preparing for participation at the market place 50. A person in charge in the first parts maker 10 registers at the first parts maker home page 11 a stock status of parts possessed by the first parts maker 10 (step A1). An example of the first parts maker home page 11 is shown in FIG. 5. The first parts maker home page 11 shown in FIG. 5 registers therein products Nos. BUHIN00, BUHIN01, and BUHIN02 and stock quantities 1000, 2000, and 5000 as information corresponding to product names X, Y, and X respectively.

Next, the first parts maker 10 pays a participation fee to an operator of the market place 50 in order to participate there to then post its own internet address to him (step A2). The operator of the market place 50 registers thus posted address at the database 53 (step A3).

FIG. 3 is a flowchart for showing a procedure for most recently updating the information of the first parts maker home page 11 always. In the stock control server 13, the program for monitoring the updated status of the stock information is activated upon system activation and resident there (step B1). If the stock information is updated (step B2), the resident program operates to post new stock information to the Web server 12 (step B3). Based on the posted new information, the Web server 12 updates the first parts maker home page 11 (step B4).

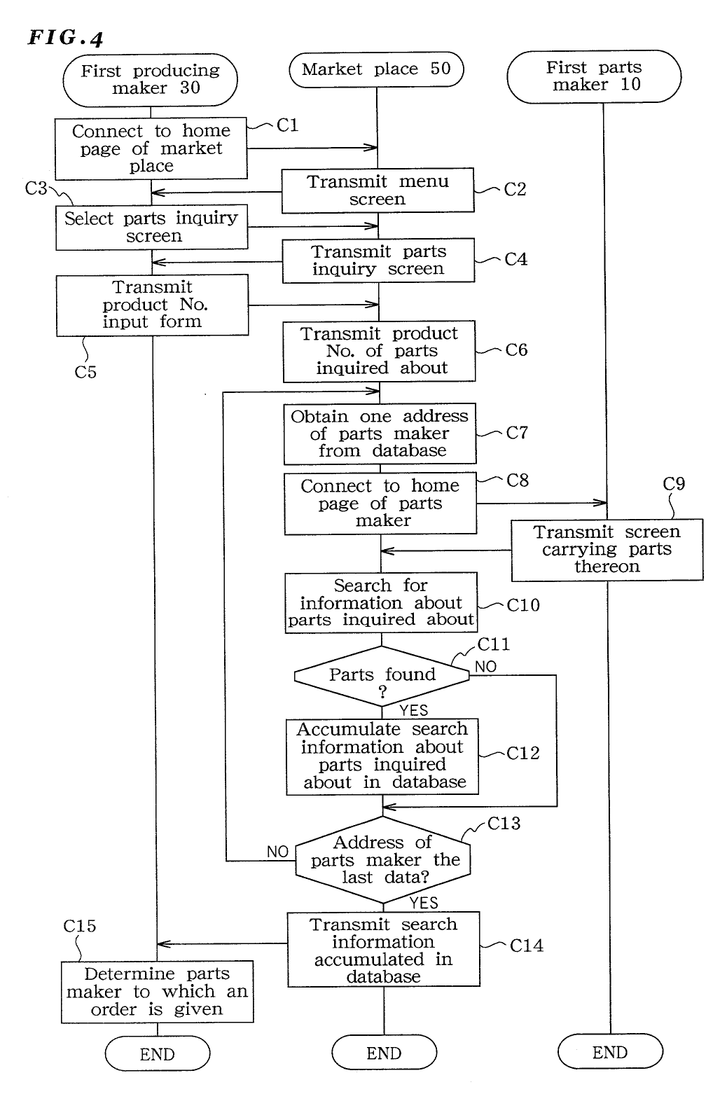

FIG. 4 is a flowchart for showing a process of a step of the first parts maker 30 making an inquiry to the market place 50 about its necessary parts up to a step of obtaining an inquiry result. The person in charge in the first producing maker 30 connects through the terminal 31 to the home page 51 of the market place 50 (step C1). Note here that before connection to the market place 50, the producing maker 30 is supposed to make a request to the market place 50 for the connection and pay a charge for use. In response to this request for connection, the server 52 of the market place 50 transmits a menu screen (data displayed on the menu screen) to the terminal 31 of the first producing maker 30. The first producing maker 30, based on the screen received, selects a parts inquiry screen (step C3). In response thereto, the server 52 transmits the parts inquiry screen to the terminal 31 (step C4). The person in charge in the first producing maker 30 enters a product No. of the parts inquired about and transmits it to the server 52 (step C5). In response thereto, the server 52 temporarily the product No. of the parts inquired about (step C6). Next, it accesses the database 53 of the market place 50 to obtain one internet address of those of a plurality of parts makers registered at the market place 50 (step C7). It uses that address to connect to a home page of the corresponding parts maker (step C8). If the address is of the first parts maker 10, correspondingly the Web server 12 of the first parts maker 10 transmits to the server 52 a screen which gives the parts information shown in FIG. 5.

The server 52 automatically search a screen file of the parts information sent from the first parts maker 10 for the parts inquired about to thereby obtain information about whether the first parts maker 10 has the parts in stock (step C10). Next, it checks for whether the parts are actually possessed (step C11) and, if so, obtains information of a stock quantity of the parts and stores that information along with a parts maker name, a product No., and a product name in the database 53 (step C12). If the parts cannot be found, the process goes to step C13. At step C13, it checks for whether the address obtained at step C7 is the last data of the addresses of the parts makers registered in the database 53 (step C13). If it is found not so, the process returns to step C7 to obtain the next parts maker's internet address and then repeat the processing from step C7 onward likewise. In this case, however, the access destination is not the first parts maker 10 but another parts maker such as the X'th parts maker 20. If it is found to be the last data, the process goes to step C14. At step C14, stock statuses of every parts makers accumulated in the database 53 are transmitted on a screen of such a format as shown in FIG. 6 to the terminal 31 of the first producing maker 30 (step C14). The screen of FIG. 6 shows one example of a case where a product No. of a parts inquired about by the person in charge in the first producing maker 30 at step C5 is BUHIN00, specifically indicating the parts makers (first parts maker, X'th parts maker, . . . ) having product No. BUHIN00 in stock and their respective stock quantities (1000, 3000, . . . ). The person in charge of the first producing maker 30 references the screen returned form step C14 to thereby determine a parts maker to which an order is given for the parts (step C15).

The features of this embodiment may be summarized as follows. In FIG. 1, the first parts maker 10 manages a stock status of its own parts using the stock control server 13 and the database 14. In the stock control server 13 is resident the program which monitors the stock status, by which if the stock quantity is changed, information of an updated stock quantity is automatically transferred to the Web server 12 to thereby display the most recent stock status in the first parts maker home page 11. The first parts maker 10, on the other hand, pays a registration fee to the market place 50 to register its own network address in the database 53 of the market place 50. The market place 50 has the addresses of a plurality of parts makers registered therein by the same method. The first producing maker 30 pays a charge for use to the market place 50 to be permitted to access the home page 51 of the market place 50 through the terminal 31, thus making an inquiry to the market place 50 about the product No. and the quantity of necessary parts. In the parts inquiry processing at the market place 50, if some parts are inquired about, the network addresses of the parts makers registered in the database 53 are sequentially read out to make access to their home pages. If any of the parts makers' home pages stores a product No. of the parts inquired about, a stock quantity of the parts is returned to the terminal of the first producing maker 30 that inquired about the parts. Based on the returned information, the first producing maker 30 gives the parts maker an order for the parts.

Note here that in the above-mentioned embodiment the program for realizing various function at such an information processing machine that is comprised of the components shown in FIG. 1 can be recorded in a computer-readable medium or distributed over a communications line. Also, the functions realized at each server may be given instead by a plurality of servers arranged over a communication line in a distributed manner.

Also, parts (component parts) of the invention refer to a product constituting part of an apparatus, a machine, or a system, so that if it is part of a system, it may have such an aspect individually usable or may include a component or service required to constitute or maintain the system.

Although the embodiment of the invention has been described in detail with reference to the drawings, the specific configuration is not limited thereto and includes any others such as variants in design without departing the gist of the invention. For example, an inquiry may be made about quantities of many parts at a time or stock quantities of ordered parts searched for may be displayed along with information about a time lapse or a cost required in delivery.

As may be clear from the above, the invention gives the following effects. As the first effect, the parts information can be distributed over the servers of various parts makers which hold it to thereby permit the market place to only mediate the information, thus reducing the operation costs at the market place. As the second effect, the person in charge in a producing maker, if he must acquire parts in emergency, need not directly make an inquiry to those parts makers for stock quantities through a telephone, a fax, or the internet, thus enabling giving an order securely and rapidly. As the third effect, if only one parts maker is not enough to acquire a required quantity of parts, it is possible to rapidly know how much stock quantities does each of the parts makers have, so that an order for necessary parts can be made to a plurality of parts makers to acquire the parts, thus minimizing the possibility of the producing makers of losing the chance. Accordingly, the invention enables the producing maker to acquire necessary parts using electronic commerce in a short delivery time limit as compared to a prior art system. As the fourth effect, since the home page of a parts maker always carries the most recent stock information therein, the latest information can be returned to an inquirer in response to an inquiry from the market place for parts.

The invention may be embodied in other specific forms without departing from the spirit or essential characteristic thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2000-286100 (Filed on Sep. 20^{th}, 2000) including specification, claims, drawings and summary are incorporated herein by reference in its entirety.

What is claimed is:

1. A parts acquisition system having a plurality of servers connected to a network, comprising:
a first server for providing information about a stock status of parts through said network; and
a second server for receiving information specifying search-subject parts and, based on said information about a stock status of parts provided from said first server, searching for information about said specified parts to then return a search result.

2. The parts acquisition system according to claim 1, wherein said information about a stock status of parts contains information indicating a stock quantity of said parts.

3. The parts acquisition system according to claim 1, wherein said second server handles information received from a user who made a request before, as information for specifying said search-subject parts.

4. The parts acquisition system according to claim 2, wherein said second server handles information received from a user who made a request before, as information for specifying said search-subject parts.

5. The parts acquisition system according to claim 1, wherein said second server searches said first server registered beforehand under predetermined registration conditions in a database managed by said second server.

6. The parts acquisition system according to claim 2, wherein said second server searches said first server registered beforehand under predetermined registration conditions in a database managed by said second server.

7. The parts acquisition system according to claim 1, wherein said second server returns a search result obtained from a plurality of said servers, as information that can be listed.

8. The parts acquisition system according to claim 2, wherein said second server returns a search result obtained from a plurality of said servers, as information that can be listed.

9. The parts acquisition system according to claim 1, wherein said first server provides information about a stock status of parts as information in a home page.

10. The parts acquisition system according to claim 1, wherein said first server provides information about a stock status of parts as information in a home page.

11. The parts acquisition system according to claim 1, wherein:
said first server includes a database and a server for managing information about a stock status of parts and a Web server for providing said network with information about managed parts as information in a home page; and
said second server includes a server for providing through said network a home page for receiving information specifying said search-subject parts.

12. The parts acquisition system according to claim 1, wherein:
said first server includes a database and a server for managing information about a stock status of parts and a Web server for providing said network with information about managed parts as information in a home page; and
said second server includes a server for providing through said network a home page for receiving information specifying said search-subject parts.

13. A parts acquisition method carried out using a plurality of servers connected to a network, comprising the steps of:
providing, at a first server, information about a stock status of parts through said network;
receiving, at a second server, information specifying search-subject parts to thereby search for information about said specified parts based on said information about a stock status of parts provided by said first server; and
returning a search result.
